(19) United States
(12) Patent Application Publication
(10) Pub. No.: US 2009/0261141 A1
(43) Pub. Date: Oct. 22, 2009

(54) ERGONOMIC STAPLER AND METHOD FOR SETTING STAPLES

(76) Inventors: Lawrence D. Stratton, Redmond, WA (US); Brent LaPorte, Issaquah, WA (US); Wallace White, Seattle, WA (US)

Correspondence Address: BLACK LOWE & GRAHAM, PLLC, 701 FIFTH AVENUE, SUITE 4800, SEATTLE, WA, 98104, US

(21) Appl. No.: 12/106,236

(22) Filed: Apr. 18, 2008

(51) Int. Cl. B25C 5/15; B27F 7/36

(52) U.S. Cl. 227/131; 227/120; 227/129

(57) ABSTRACT

A stapler having ergonomic benefits includes a housing situated along a principal axis. The housing is conformed to include a handle and a head with a staple discharge opening spaced apart from the handle along the principal axis. A generally planar knife is within the head and oriented in parallel to a plane defined by an intersection of the principal axis and a normal axis. A magazine includes a sole at the staple discharge opening. The sole receives at least one first strip of staples. The first strip of staples is aligned such that the bight of a first staple within the strip of staples is parallel to the principal axis and the first strip is aligned with a lateral axis orthogonal to both of the principal and normal axes.

### FIELD OF THE INVENTION

This invention relates generally to fastener setting and, more specifically, to setting of staples.

### BACKGROUND OF THE INVENTION

As shown in FIG. 1, strips of staples 3, according to the prior art, are configured of pluralities of individual staples 5, each staple optionally including a molded body 9 formed on the free end portions of the legs 7. Molded body 9 is formed of an insulating material, such as a thermoplastic resin, or the like, which is non-conductive to electricity. Molded body 9 has a generally rectangular peripheral configuration. The legs 7 each are parallel, spaced apart, and joined by a staple bight 6.

The construction of the staples 5 enables a plurality of insulated staples whose plurality of molded bodies 9 formed at the same time in a molding operation wherein, for example, the staples 5 are installed in spaced slots in a mold into which molten insulating material is poured or injected. In addition, by this construction, the molded bodies 9 are suitably molded of a frangible insulating material thereby to allow the individual staples to be set while the strip 3 of the remaining staples remains configured as an integral whole. As a result, a strip of insulated staples 3 is provided which is easily installed in a staple gun in the conventional manner.

Staple guns are generally of conventional construction such as a conventional Arrow T-50® brand staple gun such as disclosed in U.S. Pat. Nos. 2,671,215 and 2,754,515. Electricians have regularly used such staplers as are taught in U.S. Pat. No. 5,735,444 to Wingert, whose teaching is incorporated herein as though set forth herein. And as with the stapler taught in Wingert, electricians have used staplers that set staples perpendicular to a principal axis of the stapler. Use of such a stapler forces an electrician to secure shielded cable such as Romex™ to align the principal axis to the Romex™.

Within such staplers, the magazine is a generally inverted U-shaped metal frame having a bight 6 and a pair of spaced apart vertical legs 7. The lower ends of the legs include inwardly extending flanges on which the bases of molded bodies 9 will slide. Flanges aligned with and spaced apart from the principle axis thus support the strip of staples 3 in the magazine with minimal friction during movement.

The shortcomings of the prior art cause the prior art staplers to be cumbersome and tiring. Forcing the use of the prior art stapler by its alignment to the Romex™ cable moves the electrician to an awkward position as he is simultaneously required to stretch the cable and fasten it with the stapler. Powered staplers generally are unbalanced, placing the weight toward the head, much as a hammer is unbalanced. Because the powered stapler does not rely upon the swinging of the device to drive the staple, the unbalanced configuration tends to tire electricians as they must both position and support the device. Finally, because the staples are carried within the tool in sticks aligned with the principal axis, there exists no practical way to align bights of staples with the principal axis. There exists an unmet need in the art for a stapler configured to carry strips 3 of staples 5 such that the bights are aligned with the principal axis and the weight is generally equally distributed relative to a centrally located handle.

### SUMMARY OF THE INVENTION

A stapler having ergonomic benefits includes a housing situated along a principal axis. The housing is conformed to include a handle and a head including a staple discharge opening, spaced apart from the handle along the principal axis. A generally planar knife is within the head and oriented in parallel to a plane defined by an intersection of the principal axis and a normal axis. A magazine includes a sole at the staple discharge opening. The sole receives at least one first strip of staples. The first strip of staples is aligned such that the bight of a first staple within the strip of staples is parallel to the principal axis and the first strip is aligned with a lateral axis orthogonal to both of the principal and normal axes.

The present invention comprises a magazine for presenting staples to a knife for driving staples out of a stapler. The stapler has a principal axis and a generally planar sole. The sole includes a generally rectangular surface configured to receive a plurality of strips of staples arranged with bights parallel to the principal axis, such that a first strip of staples includes a first staple and is arranged to contact a second strip of staples that includes a second staple such that the bights are generally collinear. A pusher is configured to advance the strip toward a discharge opening such that the legs of the first staple are parallel to a direction of reciprocating movement of a knife. The movement is configured to drive the first staple out of the stapler through the discharge opening.

In accordance with some examples of the invention, the knife is driven in its reciprocating motion by an electric motor. In one non-limiting example, the electric motor includes one of a group consisting of a spring and a flywheel as an energy storage device. In an alternate embodiment, the electric motor is a solenoid.

In accordance with other examples of the invention, a method is disclosed for driving a staple from a stapler. The stapler is oriented along three mutually orthogonal axes including a principal axis, a lateral axis, and a normal axis. The method includes drawing a knife out of a first position, in a movement parallel to the normal axis to a second position, the knife being oriented in a housing generally parallel to a plane defined by the intersection of the principal and normal axes. Moving a staple in a movement parallel to the lateral axis generally into a space vacated by the movement of the knife allows driving the knife from the second to the first position whereby the staple is expelled out of the stapler through a staple discharge opening.

In accordance with still further examples of the invention, the driving includes driving in response to activation of a trigger.

In accordance with yet other examples of the invention, a stapler having ergonomic benefits includes a housing situated along a principal axis. The housing is configured to define a staple discharge opening and conformed to include a handle situated generally centrally along the principal axis. A head including the staple discharge opening is spaced apart from the handle along the principal axis. A generally planar knife is situated within the head and oriented in parallel to a plane defined by an intersection of the principal axis and a normal axis. The knife is configured to move from a first position to a second position spaced apart from the first position being displaced in a direction parallel to the normal axis and away from the staple discharge opening.

In accordance with still another example of the invention, a magazine includes a sole defining the staple discharge opening. The sole is configured to receive at least one first strip of staples at a first space. The first strip of staples is aligned such that the bight of a first staple within the strip of staples is parallel to the principal axis. The first strip is aligned with a lateral axis orthogonal to both of the principal and normal axes. The first space is located such that movement of the knife from the second position to the first position ejects the first staple out of the staple discharge opening.

These and other examples of the invention will be described in further detail below.

### BRIEF DESCRIPTION OF THE DRAWINGS

Preferred and alternative examples of the present invention are described in detail below with reference to the following drawings:

FIG. 1 is a perspective view of a prior art plurality of strips of staples;

FIG. 2 is a first perspective view of a flywheel embodiment;

FIG. 3 is a second perspective view of the flywheel embodiment;

FIG. 4 is a perspective view of a spring-loaded embodiment; and

FIG. 5 is a perspective view of a solenoid-driven embodiment.

### DETAILED DESCRIPTION OF THE PREFERRED EMBODIMENT

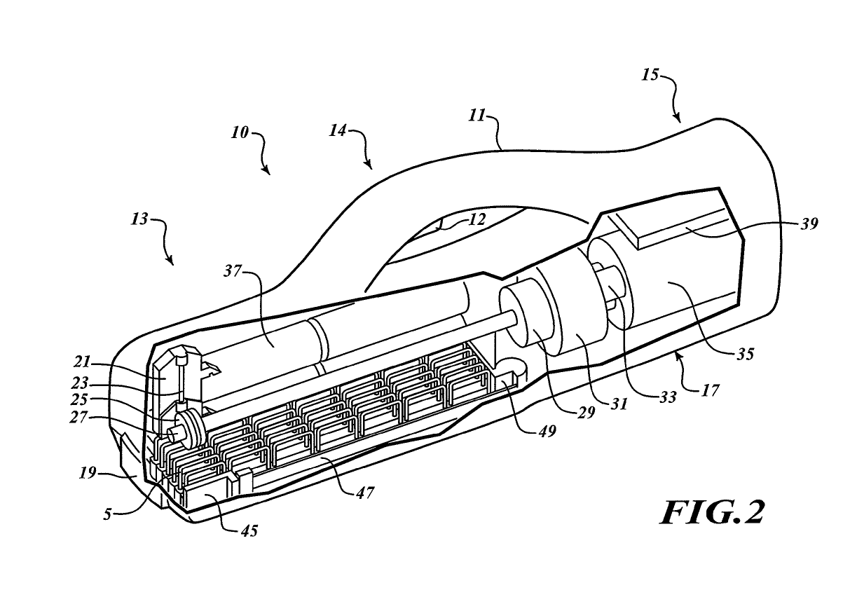

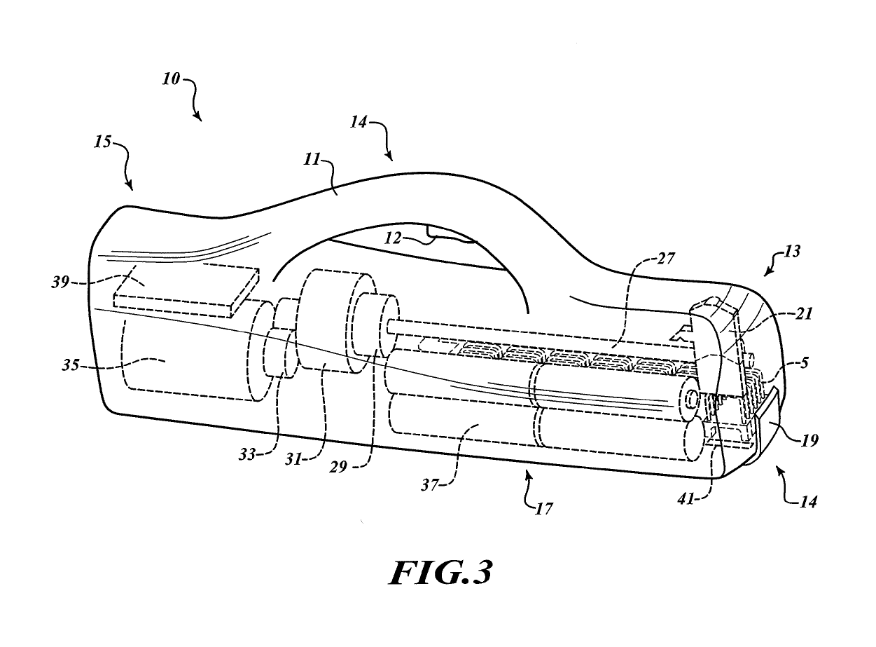

FIGS. 2 and 3 depict a perspective and a reverse perspective view of an embodiment of a stapler 10 having a housing 11 configured to define a head 13, a handle 14, and a heel 15. As is evident, the stapler 10 is situated such that its principal axis is aligned with the z-axis shown. A lateral axis generally extends from side to side or along the x-axis shown. The third axis, a normal axis, defining the direction of a driven staple, aligns with the y-axis shown. Within the handle 14, a trigger 12 is advantageously positioned to allow an operator to activate a mechanism within the housing configured to drive one of the staples 5 within the strip 3 thereby setting the staple.

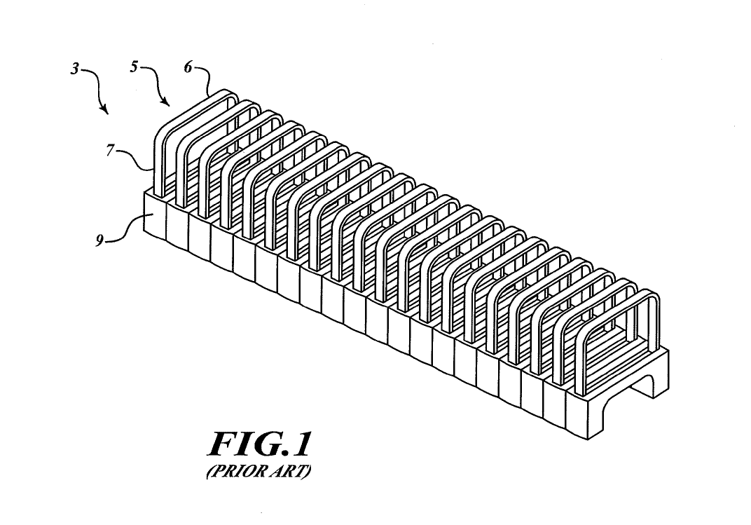

Within the housing 11 in a magazine 19, strips 3 of staples 5 are held generally as shown in FIG. 1 having a plurality of strips 3 held in parallel arrangement to the lateral axis such that individual staples 5 of adjacent strips stand leg 7 to leg 7 and align to the principal axis. Strips 3 of the inventive configuration are generally shorter than those of the prior art, though prior art strips 3 can be readily broken to suitable length.

The magazine 19 holds the strips 3 in alignment against a sole 17, parallel to a plane defined by the intersection of the principal and normal axes, of the stapler 10 with the aid of a pusher 45 and a sled 49, the sled 49 being drawn to the pusher 45 by a tensioned tape 47. In such a manner, the staples 5 are urged into alignment with a staple discharge opening 41 (not shown) such that the staples 5 in spaced relation to the discharge opening 41 through which the staple 5 can be driven. The staple 5 is urged into alignment with the discharge opening 41, the staple strip 3 is allowed to advance and thereby to position the next staple 5 in line beneath a knife 21. When the trigger 12 is activated, the knife 21 is driven down against the bight 6 (FIG. 1) of the staple 5 to drive the staple 5 through the discharge opening 41. This magazine 19, along with the knife 21, the sled 49, the tape 47, and the pusher 45, as well as the housing 11 and trigger are common to each of the embodiments pictured in FIGS. 2, 3, 4 and 5 and thus will not be recounted within the individual descriptions of those drawings. While varied means of driving the knife 21 are presented in these non-limiting embodiments, they share the magazine 19 configuration and the orientation of the knife 21 relative to the principal axis.

In the first non-limiting embodiment shown in this FIG. 2, the knife 21 is drawn downward by a cable 23. A rotating pulley 25 reels in the cable 23 as the pulley 25 rotates on a shaft 27. While a cable 23 on a pulley 25 is shown, any of a number of known means can be used to translate rotary motion into linear motion, and for that reason, the teaching of this specification is not to be limited to systems employing a cable 23. For example, instead of the pulley 25, a pinion gear might be used to drive a rack mounted on the knife 21. Similarly, a crank on the shaft 27 might engage the knife 21 at a bearing surface to drive the knife 21 downward upon rotation of the shaft 27. The cable 23 on the pulley 25 has been selected for clarity of illustration.

Rotation of the shaft 27 is occasioned in this non-limiting embodiment by a motor 35 driving a flywheel 31 by means of a transmission 33. The flywheel 31 as configured serves as a Flywheel Energy Storage (FES). The FES works by accelerating the flywheel 31 to a very high speed and maintaining the energy in the system as rotational energy. The energy is converted back by slowing down the flywheel 31 as it turns a driven shaft (not shown) in a clutch 29. The motor 35 restores the energy lost to the clutch 31 to the flywheel 31.

The clutch 29 is a mechanism for selectively transmitting rotation of a driven shaft (not shown) to a drive shaft (not shown). The clutch 29 connects the two shafts so that they can either be locked together and spin at the same speed (engaged), or be decoupled and spin at different speeds (disengaged). In typical applications the driven shaft is typically driven by a motor such as the motor 35 and, in turn, the drive shaft drives another device. In the present embodiment, the clutch 29 selectively engages the flywheel 31 to drive the shaft 27, drawing only a portion of the rotational energy of the flywheel 31. When so driven, the shaft 27, in turn, rotates the pulley 25, reeling the cable 23 drawing down the knife 21. The knife 21 drives the staple 5 out of the staple discharge opening 41 such that the bight 6 is aligned parallel to a principal axis of the stapler 10.

The motor 35 is selectively energized by a controller 39 that allows a flow of electrical current from an energy source such as, by way of non-limiting example, batteries 37. The controller 39 monitors the energy stored in the flywheel 31, increasing the rotational speed of the flywheel 31 as necessary to maintain a designated energy state within the flywheel 31. By suitably energizing the flywheel 31 and then drawing off the energy from the flywheel 31 in a sudden impulse to drive the knife 21, the motor 35, a traditional dense device whose size is generally dictated by its requisite peak performance, can be designed to be much smaller, and, thus, much lighter for the operator to carry. Nonetheless, because acceleration of the knife 21 is a function of the energy drawn from the flywheel 31 rather than generated by the motor 35, the energy storage capacity of the batteries 37 need not be as large as if the shaft 27 were turned merely by the motor 35.

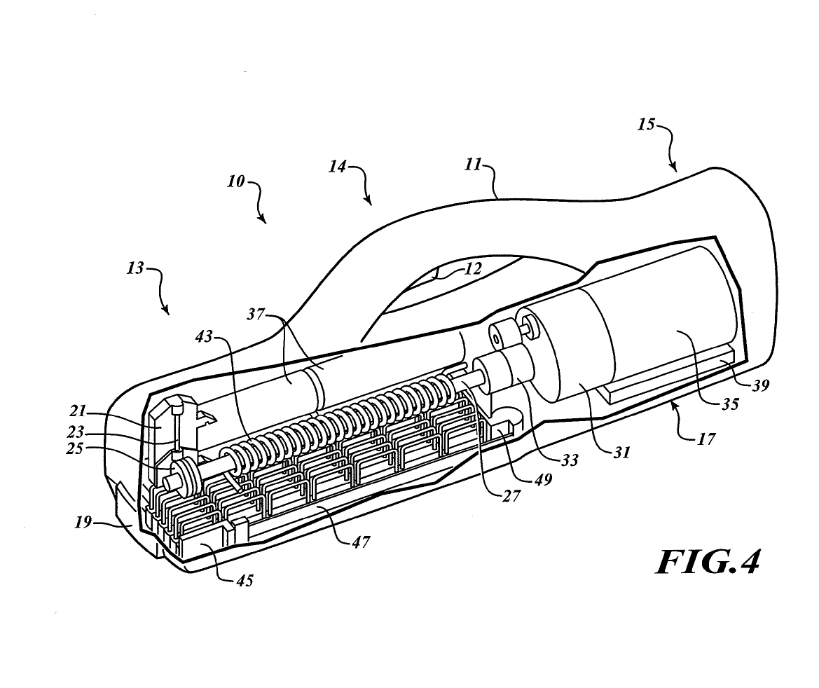

FIG. 4 depicts an alternate embodiment of the stapler, relying upon a spring 43 rather than a flywheel 31 (FIGS. 2, 3) to store energy for purposes of driving a staple 5. Many of the remaining elements are the same as those depicted in FIGS. 2 and 3. For example, the stapler 10 has the housing 11 configured to define the head 13, the handle 14, and the heel 15. As is evident, the stapler 10 is situated such that its principal axis is aligned with the z-axis shown. The lateral axis generally extends from side to side or along the x-axis shown. The third axis, the normal axis, defining the direction of a driven staple, aligns with the y-axis shown. Within the handle 14, a trigger 12 is advantageously positioned to allow an operator to activate a mechanism within the housing configured to drive one of the staples 5 within the strip 3 thereby setting the staple. Batteries 37 power the electric motor 35 in response to the controller 39. Unlike the earlier embodiment, here, the rotation of the electric motor 35 is conveyed through the transmission 33 to “wind” the spring 43.

Upon activation of the trigger 12, the potential energy stored in the “wound” spring 43 is released to the shaft 27 to rapidly turn the pulley 25, drawing in the cable 23, drawing the knife 21 from the second position to the first position and ejecting the staple 5 out of the staple discharge opening 41. In all other regards, the device operates as the first embodiment shown in FIGS. 2 and 3. The staples 5 in strips 3 are similarly urged into alignment with the knife 21 when the knife 21 is in the second position.

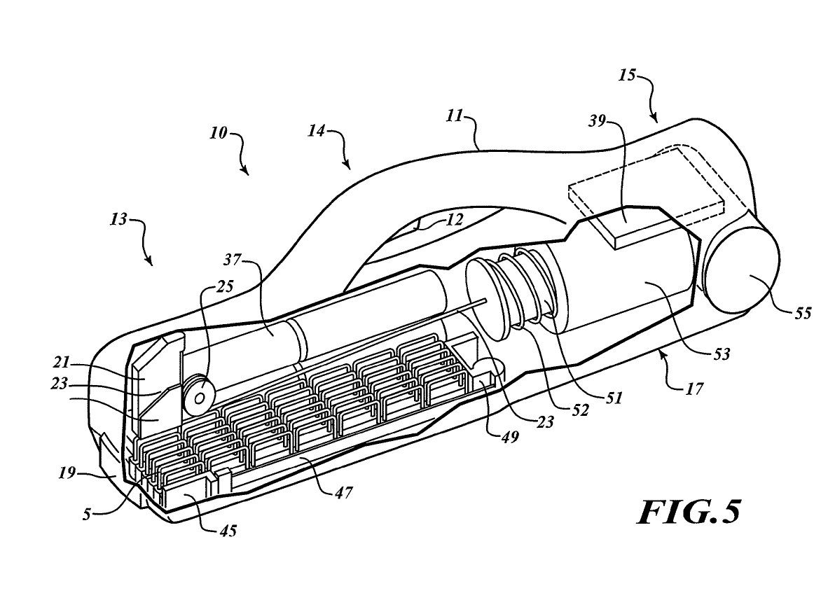

Referring to FIG. 5, a third embodiment of the device is shown. In this third non-limiting embodiment, a solenoid 53 is substituted for the electric motor 35 (FIGS. 2, 3, and 4). A solenoid is a 3-dimensional coil. The term solenoid 53 refers to a loop of wire, often wrapped around a metallic core oriented along the z-axis, which then produces a magnetic field along the z-axis (the principal axis of the stapler in this embodiment) when an electrical current is passed through it.

Advantageously, the solenoid 53 will directly draw the cable 23 without the need for a shaft 27 (FIGS. 2, 3, and 4). Upon activation of the trigger 12, the solenoid 53 contracts against the pressure of a plunger spring 52. Attached, as it is, to the solenoid 53, the cable 23 is drawn through the pulley 25 drawing the knife 21 from the second position to a first position, thereby ejecting a staple 5 from the strip 3 out of the staple discharge opening 41.

To aid the solenoid 53 in the rapid generation of a magnetic field by adding more electrons to the current in the solenoid 53, a capacitor 55 is used in a manner that resembles its use in a photographic strobe light. The capacitor 55 is an electrical device that can store energy in the electric field between a pair of conductors (called “plates”). The process of storing energy in the capacitor 55 is known as “charging,” and involves electric charges of equal magnitude, but opposite polarity, building up on each plate.

Capacitors are often used in electric and electronic circuits as energy-storage devices. The capacitor 55 is charged by current flowing through the controller 39 from the batteries 37. The capacitor 55 then acts as a reservoir for charge that will supply a surge of current to the solenoid 53 upon activation of the trigger 12. The reservoir capacitor 55 will discharge into the solenoid 53 assuring its rapid and complete contraction, drawing the cable 23 through the pulley 25, in turn, drawing the knife 21 from the second position to a first position to eject the staple 5.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or: privilege is claimed are defined as follows:

1. A magazine for presenting staples to a knife for driving out of a stapler, the stapler having a principal axis:
a generally planar sole including a generally rectangular surface configured to receive a plurality of strips of staples arranged with bights parallel to the principal axis, such that a first strip of staples including a first staple is arranged to contact a second strip of staples including a second staple such that the bights are generally collinear; and
a pusher configured to advance the strip toward a discharge opening such that the legs of the first staple are parallel to a direction of reciprocating movement of a knife, the movement configured to drive the first staple out of the stapler through the discharge opening.

2. The magazine of claim 1, such that the stapler is configured within a housing including the sole.

3. The magazine of claim 1, wherein the knife is driven in its reciprocating motion by an electric motor.

4. The magazine of claim 3, wherein the electric motor includes one of a group consisting of a spring and a flywheel as an energy storage device.

5. The magazine of claim 3, wherein the electric motor is a solenoid.

6. The magazine of claim 3, wherein the electric motor includes a cable drawing the knife in its reciprocal motion.

7. A method for driving a staple from a stapler, the stapler being oriented along three mutually orthogonal axes including a principal axis, a lateral axis, and a normal axis, the method including:
drawing a knife out of a first position, in a movement parallel to the normal axis to a second position, the knife being oriented in a housing generally parallel to a plane defined by the intersection of the principal and normal axes;
moving a staple in a movement parallel to the lateral axis generally into a space vacated by the movement of the knife;
driving the knife from the second to the first position whereby the staple is expelled out of the stapler through a staple discharge opening.

8. The method of claim 7, wherein the driving includes driving in response to activation of a trigger.

9. The method of claim 8, wherein the housing defines a handle and the trigger is mounted on the handle.

10. The method of claim 7, wherein the driving includes receiving kinetic energy from an electric motor.

11. The method of claim 10, wherein receiving kinetic energy from an electric motor includes receiving kinetic energy stored in a rotating flywheel.

12. The method of claim 10, wherein receiving kinetic energy from an electric motor includes receiving kinetic energy stored in a spring.

13. The method of claim 10, wherein the electric motor is a solenoid.

14. A stapler having ergonomic benefits, the stapler comprising:
a housing situated along a principal axis, the housing configured to define a staple discharge opening and conformed to include a handle situated generally centrally along the principal axis, a head including the staple discharge opening, and spaced apart from the handle along the principal axis; and
a generally planar knife situated within the head and oriented in parallel to a plane defined by an intersection of the principal axis and a normal axis, the knife configured to move from a first position to a second position spaced apart from the first position being displaced in a direction parallel to the normal axis and away from the staple discharge opening.

15. The stapler of claim 14, further comprising a magazine, the magazine including:
a sole defining the staple discharge opening, the sole being configured to receive at least one first strip of staples at a first space, the first strip of staples being aligned such that the bight of a first staple within the strip of staples is parallel to the principal axis and the first strip is aligned with a lateral axis orthogonal to both of the principal and normal axes, the first space being located such that movement of the knife from the second position to the first position ejects the first staple out of the staple discharge opening.

16. The stapler of claim 15, wherein a pusher urges the a second staple in the first strip into an interspace between the second position and the staple discharge opening as the knife moves from the first to the second position.

17. The stapler of claim 16, wherein a sled urges a second strip of staples into the first space once the first strip of staples has been ejected through the staple discharge opening.

18. The stapler of claim 14 wherein an electric motor urges the knife between the first and the second positions.

19. The stapler of claim 18, wherein the electric motor includes one of a group consisting of a spring and a flywheel, the group being configured to store energy from the electric motor.

20. The stapler of claim 18, wherein the electric motor is a solenoid.
